(19) United States
(12) Patent Application Publication
(10) Pub. No.: US 2004/0093942 A1
(43) Pub. Date: May 20, 2004

(54) Level gauge for measuring the amount of liquid in a tank

(76) Inventor: Per Morten Brun, Tofte (NO)

Correspondence Address: MAINE & ASMUS, 100 MAIN STREET, P O BOX 3445, NASHUA, NH, 03061-3445, US

(21) Appl. No.: 10/467,355

(22) PCT Filed: Feb. 6, 2002
(86) PCT No.: PCT/NO02/00051

(30) Foreign Application Priority Data
Feb. 7, 2001 (NO) 2001 0650

(51) Int. Cl. G01F 23/18; G01F 23/62

(52) U.S. Cl. 73/301; 73/306; 73/319

(57) ABSTRACT

A level gauge (1) for measuring the amount of liquid in a tank, such as a ground tank (19) containing fuel (21, is disclosed. The level gauge (10 comprises a probe (2) having a pressure sensor based on registration of hydrostatic pressure differential between the liquid and the tank atmosphere. The probe (2) is submersed in the liquid and is located adjacent to the bottom of the tank. The probe (2) is in tank atmospheric communication with an air trap (4), which is located in the tank atmosphere above the surface of the body of liquid.

The present invention relates to a level gauge for measuring the amount of liquid in a tank, such as a ground tank containing fuel, in which the level gauge comprises a probe having a pressure sensor based on registration of hydrostatic pressure differential between the liquid and the tank atmosphere.

It is common that gas or petrol stations have trenched ground tanks for storing fuel, either it be petrol/gasoline or diesel. The ground tanks are emptied as automobiles are filled up with fuel via the diesel and petrol pumps. When they are emptied for a certain amount, they are in turn refilled from tank lorries and this emptying and filling process is continuously ongoing.

Petrol dealers are often instructed to perform daily measurements of the ground tanks. This is primarily reasoned by the fact that fuel leakages to the environments are to be discovered. Even if use of electronic equipment for tank measurements gradually has been developed, manual measurement by use of dipstick directly into the tank is still common practice. It is self explanatory that this is a relatively rough measuring method and substantial leakages need to be present before they are discovered. In addition it is time and resource demanding and often results in that the person performing the measurements is subjected to fuel spill which creates odour that is not very compatible with the activity of kiosk sale thereafter.

By the now proposed level gauge, one will be able to discover even small leakages from a tank.

A further requirement that is introduced in quite many countries is that the volatile fuel vapours present in vehicle fuel tanks are to be collected when the tanks are filled up. This is taken care of in that the nozzle of the fuel gun has an additional opening having a subpressure that sucks in the vapours during fuel filling. The vapours are carried back to the ground tank where a majority of the vapours condense and are added to the tank content. This, however, means that the ground tanks need to be manufactured as closed systems such that the vapours are not passing out to the ambient air. Nevertheless, they are so arranged that a valve is included letting fresh air into the ground tank as they are emptied. Also a safety valve that relieves an overpressure if this exceeds a predetermined value is included.

These conditions, however, create a problem for present electronic measurement equipment, which in little extent regards the pressure condition within the ground tank. This will evidently be a source for incorrect read off level and thus the liquid quantity in the tank. By the now proposed level gauge one will compensate for an overpressure within the ground tank.

This is achieved with a level gauge of the introductorily described kind, which is distinguished in that the probe is submersed in the liquid and is located adjacent to the bottom of the tank, and that the probe is in tank atmospheric communication with an air trap spaced apart from the probe and in the tank atmosphere.

By this solution, such effect is in addition achieved that liquid or fuel is prevented from penetrating into the tank atmospheric communication between the probe and the air trap.

In an appropriate embodiment, the tank atmospheric communication, in all simplicity, is in the form of a flexible hose.

In a preferable embodiment, the air trap is in the form of an elongated pipe which in a tank mounted state, is substantially vertically erected, where the pipe in the lower end portion thereof comprises at least one aperture for communication between the interior of the pipe and the atmosphere of the tank.

As a proper safety measure, the tank atmospheric communication, or the hose, may terminate in the upper portion of and within the elongated pipe.

Preferably the probe is connected to the air trap via a combined cable comprising electric conductors, load supporting element and the tank atmospheric communication.

In order to prevent that the probe in mounted position is exposed to oscillating motion during filling of the tank, the probe may include an anchor in the lower extension thereof for contact with the bottom of the tank.

In order to secure a stable and reliable operation of the probe, the anchor has a restricted vertical freedom of motion relative to the probe.

As an optional function, the probe may include a float in the lower extension thereof for warning if water is present in the tank. The density of the float is between the density of water and the liquid, such as a fuel.

In a suitable embodiment, the float is such arranged that it has a restricted vertical freedom of motion relative to the probe, and a permanent magnet is part of the float and the magnet co-operate with a switch associated to the probe.

The invention also relates to a method for installation of a level gauge for measuring the quantity of liquid in a tank, such as a ground tank containing fuel, in which the level gauge comprises a probe having a pressure sensor where the probe, in a tank mounted position, in the lower extension thereof comprises an anchor for contact with the bottom of the tank and the anchor has a restricted vertical freedom of motion relative to the probe, characterised in that the probe including the anchor is lowered into the tank until the anchor reaches the bottom of the tank and until the weight of the probe is resting against the anchor, that the probe then is elevated to predetermined height within said freedom of motion while the anchor remains resting on the bottom of the tank.

Other and further objects, features and advantages will appear from the following description of one for the time being preferred embodiment of the invention, which is given for the purpose of description, without thereby being limiting, and given in context with the appended drawings where:

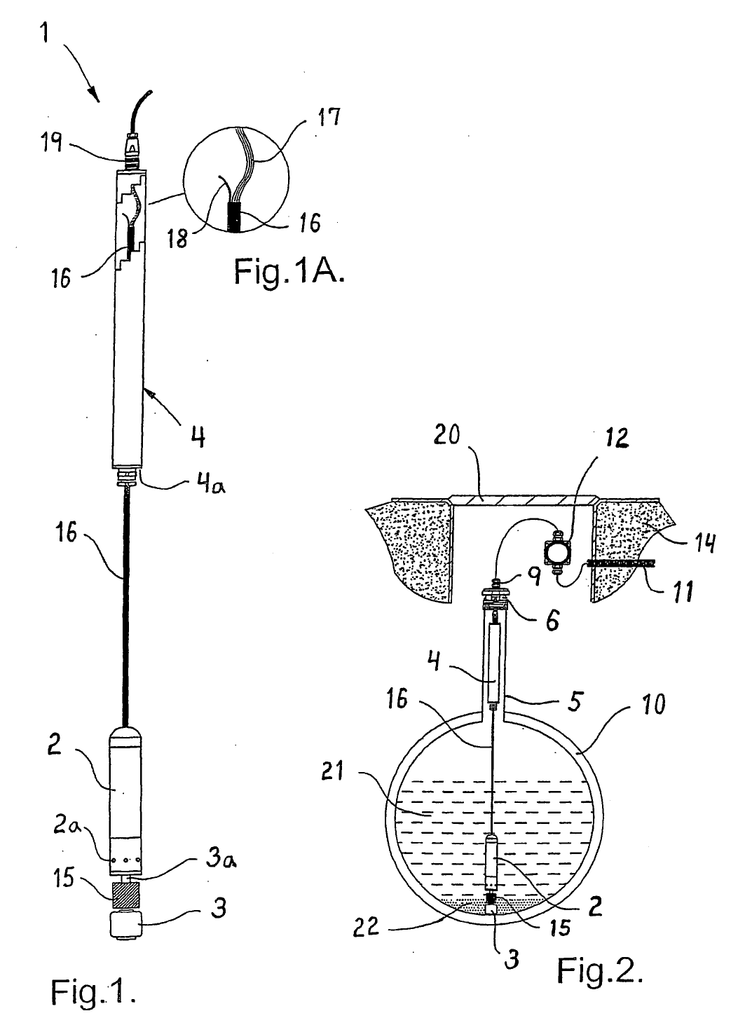

FIG. 1 shows an elevation view of the level gauge according to the present invention,

FIG. 1A shows in enlarged scale the termination of the tank atmospheric communication within the air trap, and

FIG. 2 shows schematically the level gauge according to FIG. 1 installed within a ground tank.

The invention will now be described in connection with a ground tank for fuel, such as petrol and diesel. Even if the invention is developed in this regard, it is to be understood that the level gauge can be used for quantity measurements in any conceivable tank containing a liquid, for example bulk tanks, fuel vessels and ballast tanks in ships, storing tanks on shore, chemical solution tanks, water tanks, LPG tanks etc.

Reference is firstly made to FIG. 1 that shows de respective components of the level gauge 1. The level gauge 1 includes a probe 2 having an integrated pressure sensor. The probe 2 has a number of apertures 2a letting the liquid into the probe 2. The pressure sensor within the probe is of per se known type and is based on registration of hydrostatic pressure differential between the liquid in a tank and the tank atmosphere above the liquid surface.

At the lower extension of the probe 2 is an anchor 3 arranged. The anchor 3 is connected to the probe 2 via an axle pin 3a. The anchor 3 has a restricted axial freedom of motion relative to the axle pin 3a. This axial freedom of motion will normally be in order of magnitude 5 mm.

Further is a float 15 provided on the axle pin 3a between the probe 2 and the anchor 3. The float 15 is axially movable along the axle pin 3a. An annular permanent magnet is moulded into the float 15 and thus is embracing the axle pin 3a. Within the axle pin is a current switch in the form of a reed relay provided, which is activated by the permanent magnet when the magnet passes.

The probe 2 is connected to an air trap 4 via a cable 16. The cable 16 comprises electric conductors 17 to the pressure sensor and the reed relay. The cable 16 further comprises a load carrying element in the form of a thin wire, and a tank atmospheric communication in the form of a thin hose 18 communicating the pressure within the air trap 4 to the pressure sensor within the probe 2. Thus it is to be understood that the pressure sensor at one side is influenced by the pressure in the liquid and at the other side influenced by the pressure in the tank—also if this deviates from the ambient atmospheric pressure. The thin wire carries the weight of the probe 2, the anchor 3 and the float 15, such that no load transmission occurs in the electric conductors 17 and the hose 18.

The air trap 4 includes an outer, elongated pipe and the cable 16 passes into the pipe at the lower end thereof At the lower end of the pipe is also a number of apertures 4a provided, which communicate the pressure prevailing externally of the pipe to the interior of the air trap 4. As shown in closer detail in FIG. 1A, the hose 18 transmitting the pressure terminate at the upper end of the air trap 4. The electric conductors 17 pass on and exit through a gland 19 at the upper part of the pipe.

Reference is now made to FIG. 2 that illustrates a level gauge 1 as it is mounted within a ground tank 10. At ground level a manhole 20 for access to the tank 10 is located. The level gauge 1 is suspended through a riser pipe 5, alternatively a dip pipe, which extend upwards from the ground tank 10. The suspension itself happens via a coupling piece 6 on top of the riser pipe 5. The cable 16 passes through a gland 9 provided on the coupling piece 6. The cable 16 extends further to a sealable coupling box 12 and into a guiding pipe 11 trenched into the ground 14 and up to a metering station on the surface.

As it appears from FIG. 2, the probe 2 is placed adjacent to the bottom of the ground tank 10 and it is submersed in the fuel 21. The small apertures 2a in the probe 2 communicate the fuel 21 into the probe 2 and the fuel is in contact with one side of the pressure sensor (not shown).

The float 15 is to alert if substantial quantities of water 22 is present at the bottom of the tank 10. The float 15 has a density between the density of water, i.e. 1.0 g/cm³, and the fuel, i.e. in the range of 0.72-0.78 g/cm³ for petrol and 0.82-0.87 g/cm³ for diesel. The density of the float for this purpose will typically be in the range of 0.90-0.92 g/cm³. When the water level rises, the water 22 at a certain level will elevate the float 15 and activate the reed relay, which is a switch connecting an electric circuit and delivers a signal to the metering station on the surface. Then it will be on time to pump out the water 22 from the tank 10.

When the level gauge 1 is to be installed, the probe 2 and the anchor 3 are lowered into the tank 10 until the anchor 3 reaches the bottom of the tank. The person who conducts the installation will notice when the anchor 3 reaches the bottom, and provides for that the probe 2 is not lowered further down in order not to lay down, but is kept in vertical orientation. The probe 2, however, is lowered until its weight rests against the anchor 3 for obtaining a reference. Then the probe 2 is elevated until a predetermined height within the said freedom of motion is obtained, i.e. normally 2-3 mm upward from the anchor 3. The person performing the installation will notice if also the anchor 3 is lifted from the bottom. The anchor 3 is to remain resting on the bottom of the tank 10 in order to secure stability of the probe 2, i.e. avoid oscillating motion of the probe 2.

As it also appears from FIG. 2, the air trap 4 is to be mounted in the atmosphere of the tank 10, i.e. in adequate distance from the fuel 21. It is nevertheless so arranged that if the tank 10 by accident is flooded, this shall not create operational problems for the level gauge 1. If the air trap 4 should be surrounded by fuel 21, the location of the apertures 4a in the bottom of the air trap 4 will create a safety measure in that the fuel 21 will not rise noticeably within the air trap 4. This is a very central feature of the air trap 4 since fuel 21 by all means should be prevented in reaching the open end of the hose 18, as shown in FIG. 1A. If fuel 21 enters the hose 18, this will influence on the tank atmospheric pressure, i.e. the reference pressure, and results in measurement errors.

1. A level gauge (1) for measuring the quantity of liquid in a tank, such as a ground tank (19) containing fuel (21), which level gauge (1) comprises a probe (2) having a pressure sensor based on registration of hydrostatic pressure differential between the liquid and the tank atmosphere, where the tank atmosphere is exposed to pressure fluctuations different from the ambient atmosphere, and the probe (2) is submersed in the liquid and is located adjacent to the bottom of the tank, characterised in that the probe (2) is in tank atmospheric communication via an air trap (4), which is spaced apart from the probe (2) and located in the tank atmosphere.

2. The level gauge according to claim 1, characterised in that the tank atmospheric communication is in the form of a flexible hose (18).

3. The level gauge according to claim 1 or 2, characterised in that the air trap (4) is in the form of an elongated pipe which in a tank mounted state, is substantially vertically erected, where the pipe in the lower end portion thereof comprises at least one aperture (4a) for communication between the interior of the pipe and the atmosphere of the tank.

4. The level gauge according to claim 3, characterised in that the tank atmospheric communication terminates in the upper portion of and within the elongated pipe.

5. The level gauge according to any of the claims 1-4, characterised in that the probe (2) is connected to the air trap (4) via a combined cable (16) comprising electric conductors (17), load supporting element and the tank atmospheric communication.

6. The level gauge according to any of the claims 1-5, characterised in that the probe (2), in tank mounted position, includes an anchor (3) in the lower extension thereof for contact with the bottom of the tank.

7. The level gauge according to claim 6, characterised in that the anchor (3) has a restricted vertical freedom of motion relative to the probe (2).

8. The level gauge according to any of the claims 1-7, characterised in that the probe (2), in tank mounted position, includes a float (15) in the lower extension thereof for alerting if water (22) is present in the tank, the density of the float (15) is between the density of water (22) and the liquid, such as a fuel (21).

9. The level gauge according to claim 8, characterised in that the float (15) has a restricted vertical freedom of motion relative to the probe (2), that a permanent magnet is part of the float (15) and a co-operating switch is associated with the probe.
